(19) United States
(12) Patent Application Publication
(10) Pub. No.: US 2023/0409316 A1
(43) Pub. Date: Dec. 21, 2023

(54) IN-VEHICLE ECU, PROGRAM, AND INFORMATION PROCESSING METHOD

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Shinichi AIBA, Yokkaichi-shi, Mie (JP)

(21) Appl. No.: 18/252,434

(22) PCT Filed: Oct. 25, 2021
(86) PCT No.: PCT/JP2021/039220

§ 371 Date: May 10, 2023

(30) Foreign Application Priority Data
Nov. 12, 2020 (JP) 2020-188815

(51) Int. Cl. G06F 8/71; G06F 8/65; G06F 21/62

(52) U.S. Cl. CPC G06F 8/71; G06F 21/629; G06F 8/65

(57) ABSTRACT

An in-vehicle ECU mounted on a vehicle includes: a control unit configured to execute a plurality of programs; a verification unit configured to verify each of the plurality of programs when the ECU is to be booted; a first storage region in which each of the plurality of programs is stored; and a second storage region in which each of a plurality of saved programs corresponding to the plurality of programs is stored. The control unit executes a program of which a result of verification performed by the verification unit is positive, does not execute a program of which a result of verification performed by the verification unit is negative, and executes a saved program corresponding to the program of which the result of verification is negative.

### CROSS-REFERENCE TO RELATED APPLICATIONS

This application is the U.S. national stage of PCT/JP2021/039220 filed on Oct. 25, 2021, which claims priority of Japanese Patent Application No. JP 2020-188815 filed on Nov. 12, 2020, the contents of which are incorporated herein.

### TECHNICAL FIELD

The present disclosure relates to an in-vehicle ECU, a program, and an information processing method.

### BACKGROUND

ECUs (Electronic Control Units) for controlling in-vehicle devices such as an ECU in a power train system for engine control and an ECU in a body system for air conditioner control are mounted on a vehicle. Each ECU includes an arithmetic processing unit such as an MPU, a rewritable non-volatile storage unit such as a RAM, and a communication unit for communicating with other ECUs, and controls an in-vehicle device by reading and executing a control program stored in the storage unit. A secure boot method is known in which the integrity of the control program is verified before execution of the control program when the ECU is to be booted, and if the verification is successful, the ECU is allowed to boot (see JP 2020-144531A, for example).

In JP 2020-144531A, if the number of failures exceeds a predetermined value in verification of the integrity of a control program, fail-safe is performed so as not to boot the control program (software) that has a problem.

The ECU described in JP 2020-144531A has a problem in that no consideration is given to taking measures for a program that could not be booted due to the verification result in the secure boot.

### SUMMARY

An object of the present disclosure is to provide an in-vehicle ECU and the like that can take measures for a program that could not be booted.

An in-vehicle ECU according to an aspect of the present disclosure is an in-vehicle ECU mounted on a vehicle and including: a control unit configured to execute a plurality of programs; a verification unit configured to verify each of the plurality of programs when the ECU is to be booted; a first storage region in which each of the plurality of programs is stored; and a second storage region in which each of a plurality of saved programs corresponding to the plurality of programs is stored. The control unit executes a program of which a result of verification performed by the verification unit is positive, does not execute a program of which a result of verification performed by the verification unit is negative, and executes a saved program corresponding to the program of which the result of verification is negative.

### Advantageous Effects of Disclosure

According to an aspect of the present disclosure, it is possible to provide an in-vehicle ECU and the like that take measures for a program that could not be booted.

### BRIEF DESCRIPTION OF DRAWINGS

FIG. 1 is a schematic diagram showing an example of the configuration of an in-vehicle system including in-vehicle ECUs according to Embodiment 1.

FIG. 2 is a block diagram showing an example of a physical configuration of an in-vehicle ECU.

FIG. 3 is a flowchart showing an example of processing performed by a control unit of the in-vehicle ECU.

FIG. 4 is a flowchart showing an example of processing performed by a control unit of an in-vehicle ECU according to Embodiment 2 (in which a second storage region is used as a main memory).

FIG. 5 is a flowchart showing an example of processing performed by a control unit of an in-vehicle ECU according to Embodiment 3 (in which a legitimate program is obtained from an external server).

FIG. 6 is a diagram showing classification of program sets based on verification results.

FIG. 7 is a flowchart showing an example of processing performed by a control unit of an in-vehicle ECU according to Embodiment 4 (in which an operating system is verified).

### DETAILED DESCRIPTION OF PREFERRED EMBODIMENTS

First, embodiments of the present disclosure will be listed and described.

At least some portions of the following embodiments may be combined.

### First Aspect

In accordance with a first aspect, an in-vehicle ECU according to an aspect of the present disclosure is an in-vehicle ECU mounted on a vehicle and including: a control unit configured to execute a plurality of programs; a verification unit configured to verify each of the plurality of programs when the ECU is to be booted; a first storage region in which each of the plurality of programs is stored; and a second storage region in which each of a plurality of saved programs corresponding to the plurality of programs is stored, wherein the control unit executes a program of which a result of verification performed by the verification unit is positive, does not execute a program of which a result of verification performed by the verification unit is negative, and executes a saved program corresponding to the program of which the result of verification is negative.

According to this aspect, when the in-vehicle ECU (Electronic Control Unit) is to be booted, the verification unit verifies the plurality of programs, that is, the in-vehicle ECU performs secure boot using the verification unit. Even if the result of verification performed by the verification unit in the secure boot is negative with respect to a program stored in the first storage region, a saved program corresponding to that program is stored in the second storage region different from the first storage region, and the control unit executes the saved program. Therefore, even if the result of verification performed by the verification unit in the secure boot is negative with respect to any of the programs stored in the first storage region, it is possible to maintain functions of the in-vehicle ECU by executing a saved program stored in the second storage region as an alternative to the program that could not be booted due to the result of verification in the secure boot. The control unit determines whether or not to execute the saved program according to the verification result of each of the plurality of programs. Therefore, when verification results of only some programs of the plurality of programs are negative, it is possible to take a local measure by executing saved programs with respect to only those programs whose verification results are negative. Accordingly, even in a case where the plurality of programs are classified into a plurality of functional sections according to functions, it is possible to take a local measure in accordance with the functional sections.

### Second Aspect

In a second aspect, in the in-vehicle ECU according to an aspect of the present disclosure, the saved program corresponding to the program is an old-version program that is a previous version of the program or a backup program that is a backup of the program.

According to this aspect, the saved program executed by the control unit instead of the program of which the result of verification performed by the verification unit is negative is an old-version program that is a previous version of the program or a backup program that is a backup of the program, and has an operating record. Therefore, the in-vehicle ECU can exhibit a function equivalent to the program that could not be executed, by executing the saved program.

### Third Aspect

In a third aspect, in the in-vehicle ECU according to an aspect of the present disclosure, when executing the saved program, the control unit copies the saved program stored in the second storage region to the first storage region, overwrites the program of which the result of verification is negative, and executes the saved program using the first storage region as a main memory.

According to this aspect, the control unit copies the saved program stored in the second storage region to the first storage region, overwrites the program of which the result of verification is negative, and executes the saved program using the first storage region as the main memory. The main memory is a storage region including a memory space (memory region) that is allocated for a process generated when a program is executed by the control unit such as a CPU. Accordingly, it is possible to execute the saved program without changing the manner of access to the first storage region, which is the main memory, (i.e., without changing memory control) in the generation of a process or the like by the control unit.

### Fourth Aspect

In a fourth aspect, in the in-vehicle ECU according to an aspect of the present disclosure, when executing the saved program, the control unit executes the saved program using the second storage region, in which the saved program is stored, as a main memory.

According to this aspect, when executing the saved program, the control unit executes the saved program using the second storage region, in which the saved program is stored, as the main memory, and therefore, the need to copy the saved program to the first storage region is eliminated, and the time required to perform a series of processing when executing the saved program can be reduced.

### Fifth Aspect

In a fifth aspect, in the in-vehicle ECU according to an aspect of the present disclosure, the verification unit verifies a program and a saved program corresponding to the program, and if results of verification performed on the program and the saved program by the verification unit are both negative, the control unit obtains a legitimate program of the same type as the program of which the result of verification is negative, from an external server outside the vehicle, and executes the obtained legitimate program.

According to this aspect, the verification unit verifies the program stored in the first storage region and the saved program stored in the second storage region and corresponding to the program, and therefore, the reliability of the secure boot can be further improved. Even if the verification results of the program and the saved program corresponding to the program are both negative, the control unit executes the legitimate program obtained from the external server outside the vehicle, and therefore, functions of the in-vehicle ECU can be maintained.

### Sixth Aspect

In a sixth aspect, in the in-vehicle ECU according to an aspect, the control unit copies the obtained legitimate program to the first storage region and the second storage region, overwrites the program and the saved program of which the results of verification are negative, and executes the legitimate program using the first storage region as a main memory.

According to this aspect, when the results of verification of the program and the saved program corresponding to the program are both negative, the control unit copies the legitimate program obtained from the external server outside the vehicle to the first storage region and the second storage region, and overwrites the program and the saved program of which the results of verification are negative. Since the program and the saved program are overwritten, the program and the saved program having negative verification results are substantially erased (deleted), and both the program and the saved program stored in the in-vehicle ECU can be normalized.

### Seventh Aspect

In a seventh aspect, in the in-vehicle ECU according to an aspect of the present disclosure, when the legitimate program cannot be obtained from the external server, the control unit outputs notification information indicating that a function corresponding to the program of which the result of verification is negative cannot be exhibited.

According to this aspect, when the results of verification of the program and the saved program corresponding to the program are both negative and the legitimate program cannot be obtained from the external server, the control unit outputs notification information indicating that a function corresponding to the program that could not be executed (program having the negative verification result) cannot be exhibited, to the external server or a notification unit in which a hazard lamp or the like is used, for example. The notification information may correspond to information (rescue signal) indicating a function failure, that is, indicating that at least one function of the vehicle cannot be exhibited. For example, an in-vehicle device such as a body ECU that controls a hazard lamp or a horn may flash the hazard lamp or honk the horn, upon receiving the rescue signal. That is, the hazard lamp or the horn may be caused to function as a notification unit that gives a notification to an operator of another vehicle around the vehicle. Thus it is possible to notify a manager of the external server or the operator of the other vehicle around the vehicle of the occurrence of the function failure in the vehicle in which the in-vehicle ECU is mounted.

### Eighth Aspect

In an eighth aspect, in the in-vehicle ECU according to an aspect of the present disclosure, an operating system that generates an operation environment for executing the plurality of programs is stored in the first storage region, a saved operating system corresponding to the operating system is stored in the second storage region, the verification unit verifies the operating system in addition to the plurality of programs, if a result of verification performed on the operating system by the verification unit is positive, the control unit boots the operating system, and if the result of verification performed on the operating system by the verification unit is negative, the control unit boots the saved operating system.

According to this aspect, the verification unit verifies the operating system in addition to the plurality of programs, if the result of verification performed on the operating system (stored in the first storage region) by the verification unit is positive, the control unit boots the operating system, and if the result of verification performed on the operating system by the verification unit is negative, the control unit boots the saved operating system (stored in the second storage region). The operating system is an in-vehicle operating system such as an OS (Operating System) in accordance with AUTOSAR or Linux (registered trademark), for example. The saved operating system stored in the second storage region may be an old version of the operating system stored in the first storage region or a backup operating system of the same version as the operating system stored in the first storage region, as is the case with the programs. Therefore, it is possible to establish a secure operation environment by booting the operating system or the saved operating system based on the verification result of the operating system in the secure boot processing (secure boot sequence) executed when the in-vehicle ECU is to be booted.

### Ninth Aspect

In a ninth aspect, a program according to an aspect of the present disclosure causes a computer mounted on a vehicle and configured to execute a plurality of programs to execute processing for: performing verification of each of the plurality of programs stored in a first storage region when the computer is to be booted; executing a program of which a result of the verification is positive; and not executing a program of which a result of the verification is negative, and executing a saved program that is stored in a second storage region different from the first storage region and corresponds to the program of which the result of the verification is negative.

According to this aspect, it is possible to cause the computer to function as an in-vehicle ECU that can take measures for a program that could not be booted.

### Tenth Aspect

In a tenth aspect, in an information processing method according to an aspect of the present disclosure, a computer mounted on a vehicle and configured to execute a plurality of programs is caused to execute processing for: performing verification of each of the plurality of programs stored in a first storage region when the computer is to be booted; executing a program of which a result of the verification is positive; and not executing a program of which a result of the verification is negative, and executing a saved program that is stored in a second storage region different from the first storage region and corresponds to the program of which the result of the verification is negative.

According to this aspect, it is possible to provide an information processing method with which the computer can be caused to function as an in-vehicle ECU that can take measures for a program that could not be booted.

The following specifically describes the present disclosure based on the drawings showing the embodiments of the present disclosure. In-vehicle ECUs 2 according to the embodiments of the present disclosure will be described below with reference to the drawings. Note that the present disclosure is not limited to the following examples, but is defined by the claims, and is intended to encompass all modifications within the meanings and scope that are equivalent to the claims.

### Embodiment 1

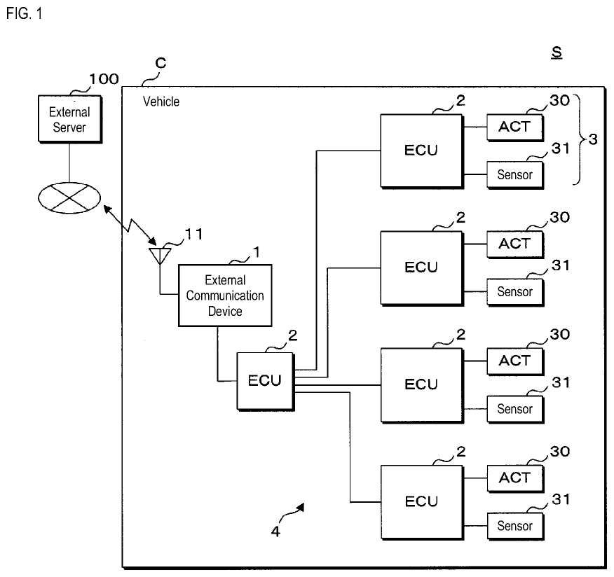

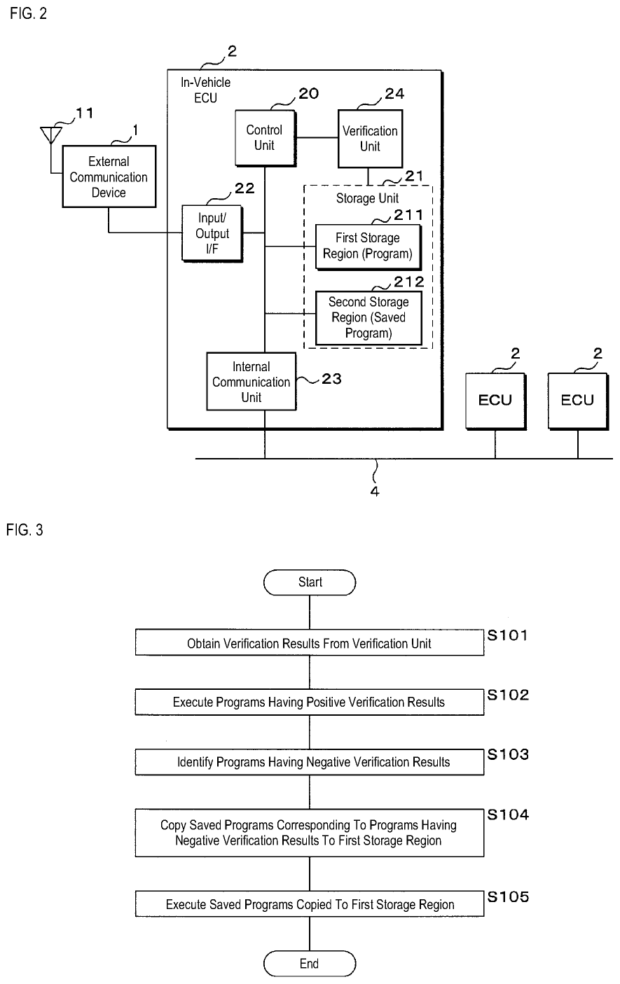

The following describes an embodiment based on the drawings. FIG. 1 is a schematic diagram showing an example of the configuration of an in-vehicle system including in-vehicle ECUs 2 according to Embodiment 1. FIG. 2 is a block diagram showing an example of a physical configuration of an in-vehicle ECU 2. An in-vehicle system S includes a plurality of in-vehicle ECUs 2 that are mounted on a vehicle C and in-vehicle devices 3 that are connected to the in-vehicle ECUs 2.

The plurality of in-vehicle ECUs 2 may include an integrated in-vehicle ECU 2 (integrated ECU) that controls the whole vehicle C, and individual in-vehicle ECUs 2 (individual ECUs) that are communicably connected to the integrated in-vehicle ECU 2 and are directly connected to the in-vehicle devices 3. The integrated in-vehicle ECU 2 may be communicably connected via an external communication device 1 to an external server 100 that is connected to an external network such as the Internet. In the illustration of the present embodiment, the integrated in-vehicle ECU 2 and the plurality of individual in-vehicle ECUs 2 are communicably connected to each other via an in-vehicle network 4 that forms a star-shaped network topology, and the integrated in-vehicle ECU 2 is at the center of the star-shaped network topology. A configuration is also possible in which individual in-vehicle ECUs 2 adjacent to each other are further connected to each other forming a loop-shaped network topology and are capable of performing bidirectional communication to realize redundancy.

The plurality of individual in-vehicle ECUs 2 are disposed in respective areas in the vehicle C, and the in-vehicle devices 3 including actuators 30 of a hazard lamp, an illumination lamp, a horn, and the like and sensors are directly connected to the individual in-vehicle ECUs 2 via wire harnesses constituted by serial cables or the like. Each individual in-vehicle ECU 2 obtains (receives) a signal (input signal) output from the sensor, and transmits a request signal generated based on the obtained input signal to the integrated in-vehicle ECU 2, for example. Each individual in-vehicle ECU 2 performs driving control of the actuator 30 of the illumination lamp or the like directly connected to the ECU based on a control signal transmitted from the integrated in-vehicle ECU 2. The individual in-vehicle ECUs 2 may be relay control ECUs that function as in-vehicle relay devices such as gateways or Ether switches that relay communication between the plurality of in-vehicle devices 3 connected to the individual in-vehicle ECUs 2 or communication between the in-vehicle devices 3 and other in-vehicle ECUs 2. The individual in-vehicle ECUs 2 may also be PLBs (Power Lan Boxes) that function as power distribution devices for distributing and relaying power output from a power storage device 5 and supplying the power to the in-vehicle devices 3 connected to the ECUs, in addition to relaying communication.

The integrated in-vehicle ECU 2 is a central control device such as a vehicle computer, for example, and generates and outputs control signals to the individual in-vehicle devices 3 based on data relayed from the in-vehicle devices 3 via other in-vehicle ECUs 2 such as the individual in-vehicle ECUs 2. Based on information or data such as request signals regarding actuators 30 output (transmitted) from the other in-vehicle ECUs 2 such as the individual in-vehicle ECUs 2, the integrated in-vehicle ECU 2 generates control signals for controlling the actuators 30, and outputs (transmits) the generated control signals to the other in-vehicle ECUs 2. In the present embodiment, the in-vehicle system is constituted by the integrated in-vehicle ECU 2 (integrated ECU) and the individual in-vehicle ECUs 2 (individual ECUs), but there is no limitation to this configuration. The in-vehicle system may be constituted by a plurality of in-vehicle ECUs 2 that are connected in the peer-to-peer manner via relay devices such as CAN (Controller Area Network) gateways or Ether switches, for example.

The in-vehicle devices 3 include: various sensors 31 such as a LiDAR (Light Detection and Ranging), a light sensor, a CMOS camera, and an infrared sensor; and the actuators 30 such as switches including a door switch (SW) and a lamp SW, a lamp, a door opening/closing device, and a motor device, for example. The external server 100 is a computer such as a server connected to a network outside the vehicle, such as the Internet or a public network, and includes a storage unit 21 constituted by a RAM (Random Access Memory), a ROM (Read Only Memory), a hard disk, or the like. The external server 100 may be an OTA (Over The Air) server that provides (transmits) update programs and the like to the vehicle C. The integrated in-vehicle ECU 2 (integrated ECU) is communicably connected to the external communication device 1 and may be configured to communicate, via the external communication device 1, with the external server 100 connected via the network outside the vehicle, and relay communication between the external server 100 and other in-vehicle ECUs 2 mounted on the vehicle C or the in-vehicle devices 3.

The external communication device 1 includes an external communication unit (not shown) and an input/output I/F (not shown) for communicating with the integrated in-vehicle ECU 2 (integrated ECU). The external communication unit is a communication device for performing wireless communication with use of a mobile communication protocol such as 4G, LTE (Long Term Evolution/registered trademark), 5G, or WiFi, and exchanges data with the external server 100 via an antenna 11 connected to the external communication unit. Communication between the external communication device 1 and the external server 100 is performed via an external network N such as a public network or the Internet. An input/output I/F 22 is a communication interface for performing serial communication with an in-vehicle ECU 2. The external communication device 1 and the in-vehicle ECU 2 communicate with each other via the input/output I/F and a wire harness constituted by a serial cable or the like connected to the input/output I/F. In the present embodiment, the external communication device 1 is separate from the in-vehicle ECU 2, and these devices are communicably connected to each other via the input/output I/F and the like, but there is no limitation to this configuration. The external communication device 1 may be included in the in-vehicle ECU 2 as a constituent unit of the in-vehicle ECU 2.

Each in-vehicle ECU 2 (integrated ECU, individual ECU) includes a control unit 20, a storage unit 21 that includes a first storage region 211 and a second storage region 212, an input/output I/F 22, an internal communication unit 23, and a verification unit 24. The control unit 20 is constituted by a CPU (Central Processing Unit), an MPU (Micro Processing Unit), or the like, and is configured to perform various types of control processing and arithmetic processing by reading and executing control programs and data stored in the storage unit 21 in advance. The control unit 20 is not limited to a software processing unit such as a CPU that performs software processing, and may also include a hardware processing unit such as an FPGA, an ASIC, or a SOC that performs various types of control processing and arithmetic processing through hardware processing.

The storage unit 21 is constituted by a volatile memory element such as a RAM (Random Access Memory), a non-volatile memory element such as a ROM (Read Only Memory), an EEPROM (Electrically Erasable Programmable ROM), or a flash memory, or a combination of these storage devices, and control programs and data that is referred to during processing are stored in the storage unit 21 in advance. The control programs include a plurality of programs (applications) such as programs (applications) for controlling the various in-vehicle devices 3 and programs (applications) for performing target recognition to realize automatic driving based on data output from a LiDAR or a CMOS camera, for example.

The storage unit 21 includes the first storage region 211 and the second storage region 212. The first storage region 211 and the second storage region 212 are configured as different regions, for example, are constituted by separate storage devices or memory devices. Alternatively, a configuration is also possible in which the storage unit 21 is constituted by a single storage device, and the internal structure of the storage device is divided into the first storage region 211 and the second storage region 212 by setting a partition to make these regions have different physical addresses, for example. The first storage region 211 is used as a main memory when the control unit 20 executes a program, and a memory space (memory region) that is allocated for a process or a thread generated in the execution of the program is any region in the first storage region 211.

A plurality of programs (applications) that are mainly executed to exhibit functions of the in-vehicle ECU 2 are stored in the first storage region 211. When these programs are referred to as programs (current version) currently executed (applied) by the in-vehicle ECU 2, programs (old version) applied before the current version are stored as saved programs (saved applications) in the second storage region 212. Alternatively, a configuration is also possible in which the same programs (the same version) as the plurality of programs stored in the first storage region 211 are stored as a backup (saved programs) in the second storage region 212.

A program stored in the first storage region 211 and a corresponding saved program stored in the second storage region 212 may be associated with each other by giving the same file name to the program and the saved program, for example. Alternatively, a program and a corresponding saved program may be associated with each other by allocating the same address number (head address) to regions in which the program and the saved program are stored in the first storage region 211 and the second storage region 212, respectively. Alternatively, individual programs may be associated with saved programs respectively corresponding to those programs in a program correspondence table stored in the storage unit 21.

The input/output I/F 22 is a communication interface for performing serial communication similarly to the input/output I/F 22 of the external communication device 1, for example. The in-vehicle ECU 2 is communicably connected to the external communication device 1 via the input/output I/F 22 and a wire harness constituted by a serial cable or the like.

The internal communication unit 23 is an input/output interface in which a communication protocol of CAN (Controller Area Network) or Ethernet (registered trademark) is used, for example, and the control unit 20 communicates with other in-vehicle ECUs 2 connected to the in-vehicle network 4, via the internal communication unit 23.

The verification unit 24 is an HSM (Hardware Security Module) or an SHE (Secure Hardware Extension), for example, and is configured as a device or module separate from the control unit 20 constituted by a CPU or the like. The verification unit 24 constituted by an HSM or the like plays a part in secure boot processing that is executed when the in-vehicle ECU 2 (the ECU including the verification unit 24) is to be booted, and is a functional module that verifies adequacy (integrity) or soundness of software, such as the plurality of programs stored in the storage unit 21, which is executed when the in-vehicle ECU 2 is booted. The verification unit 24 includes a processor for cipher processing, for example, and verifies adequacy (integrity) of software such as a program to be verified, using a cryptographic algorithm such as CMAC (Cipher-based Message Authentication Code), for example. In the secure boot processing (secure boot sequence) executed when the in-vehicle ECU 2 is to be booted, the verification unit 24 verifies adequacy (integrity) of each of the plurality of programs to be verified, and outputs verification results of the respective programs. The verification results include a positive verification result indicating that the corresponding program is proper and a negative verification result indicating that the corresponding program is improper due to having been falsified, for example.

FIG. 3 is a flowchart showing an example of processing performed by the control unit 20 of the in-vehicle ECU 2. When the vehicle C transitions from a stopped state (in which an IG switch is OFF) to a booted state (in which the IG switch is ON), for example, the control unit 20 of the in-vehicle ECU 2 performs the following processing based on the secure boot processing (secure boot sequence) that is executed when the in-vehicle ECU 2 is to be booted.

In an initial stage of the secure boot processing, the verification unit 24 verifies each of the plurality of programs. The plurality of programs are stored in the first storage region 211. The first storage region 211 is a memory space (memory region) allocated for processes or threads generated when the programs are executed by the control unit 20. The verification unit 24 is an HSM (Hardware Security Module), for example, and is configured as a device or module separate from the control unit 20 constituted by a CPU or the like. A series of processing by the control unit 20 of the in-vehicle ECU 2 is performed after verification processing is performed on each program by the verification unit 24.

The control unit 20 of the in-vehicle ECU 2 obtains verification results from the verification unit 24 (step S101). The verification results output from the verification unit 24 indicate whether verification results of the respective programs stored in the first storage region 211 are positive or negative. If the verification result of a program is positive, improper processing such as falsification has not been performed on the program, and adequacy (integrity) of the program is assured. If the verification result of a program is negative, improper processing such as falsification has probably been performed on the program, and adequacy (integrity) of the program is negated. The control unit 20 of the in-vehicle ECU 2 can recognize whether the verification result of each program stored in the first storage region 211 is positive or negative by referring to the verification results.

The control unit 20 of the in-vehicle ECU 2 executes (boots) programs of which verification results are positive based on the obtained verification results (step S102). The control unit 20 of the in-vehicle ECU 2 identifies (determines) the programs of which verification results are positive as executable programs based on the verification results, and executes the programs. When the programs are executed, processes or threads corresponding to the programs are generated. Memory spaces (memory regions) allocated for the processes or the like of the programs whose verification results are positive are any regions in the first storage region 211, that is, the first storage region 211 is used as a main memory in the execution of the programs having positive verification results.

The control unit 20 of the in-vehicle ECU 2 identifies programs of which verification results are negative based on the obtained verification results (step S103). The verification results output from the verification unit 24 include a positive verification result or a negative verification result with respect to each of the plurality of programs. Alternatively, even in the case where the verification results only include information regarding programs of which verification results are positive, the control unit 20 of the in-vehicle ECU 2 can identify programs of which verification results are negative by comparing the information with the plurality of programs stored in the first storage region 211 (storage unit 21) (i.e., obtaining a difference between the information and the programs stored in the first storage region 211). Cases where programs having negative verification results are identified are roughly classified into: a case where there is no program having the negative verification result; a case where there is a program having the negative verification result; and a case where there are a plurality of programs having negative verification results. In each of these cases, the control unit 20 of the in-vehicle ECU 2 identifies all programs having negative verification results.

With respect to each program having the negative verification result, the control unit 20 of the in-vehicle ECU 2 copies a saved program corresponding to the program to the first storage region 211 (step S104). The saved program corresponding to the program (stored in the first storage region 211) is stored in the second storage region 212, and may be an old version (previous version) of the program or a backup of the program (backup program of the same version). The second storage region 212 is constituted by, for example, a separate storage device or memory device as a region different from the first storage region 211. The program stored in the first storage region 211 and the saved program stored in the second storage region 212 may have the same file name, or may be stored in regions having the same address number (head address), or may be associated with each other in a program correspondence table stored in the storage unit 21.

With respect to each program identified as a program having the negative verification result, the control unit 20 of the in-vehicle ECU 2 copies a corresponding saved program from the second storage region 212 to the first storage region 211. When the saved program is copied from the second storage region 212 to the first storage region 211, the program (program having the negative verification result) stored in the first storage region 211 may be overwritten and substantially deleted (erased).

The control unit 20 of the in-vehicle ECU 2 executes the saved programs copied to the first storage region 211 (step S105). The control unit 20 of the in-vehicle ECU 2 executes all saved programs, which have been copied from the second storage region 212 to the first storage region 211, sequentially or at the same time. Even if improper processing such as falsification has been performed on a program stored in the first storage region 211 through attack from the outside of the vehicle, for example, a saved program corresponding to this program is stored in the second storage region 212, and therefore, is kept from being subjected to the falsification or the like, and maintains adequacy (integrity). The corresponding saved program is an old version or the same version (backup) of the program stored in the first storage region 211, and therefore, already has an operating record. Therefore, it is possible to maintain the functions of the in-vehicle ECU 2 by performing rollback processing using the saved program and executing the saved program instead of the program having the negative verification result.

When executing the saved program copied to the first storage region 211, the control unit 20 of the in-vehicle ECU 2 executes the saved program using the first storage region 211 as the main memory. Therefore, it is possible to execute the saved program without changing the manner of access to the first storage region 211, which is the main memory, (i.e., without changing memory control) in the generation of a process or the like by the control unit 20.

In the present embodiment and other embodiments described below, the series of processing is described as being performed by the control unit 20 of the in-vehicle ECU 2, but there is no limitation to this configuration. Some processing in the series of processing may be performed by a cloud server such as the external server 100 communicably connected to the in-vehicle ECU 2 or the verification unit 24 configured separately from the control unit 20. The control unit 20 may be configured to perform the series of processing in cooperation with the external server 100 or the verification unit 24.

According to the present embodiment, if the verification result of any of the programs stored in the first storage region is negative in the secure boot performed by the verification unit, the program is not executed. As an alternative to the program that could not be booted due the verification result in the secure boot, a saved program stored in the second storage region is executed, and thus the functions of the in-vehicle ECU can be maintained.

The control unit determines whether or not to execute the saved program according to the verification result of each of the plurality of programs. Therefore, when only some programs of the plurality of programs have negative verification results, it is possible to take a local measure by executing saved programs with respect to only those programs having negative verification results. Accordingly, even in a case where the plurality of programs are classified into a plurality of functional sections according to functions, it is possible to take a local measure in accordance with the functional sections.

### Embodiment 2

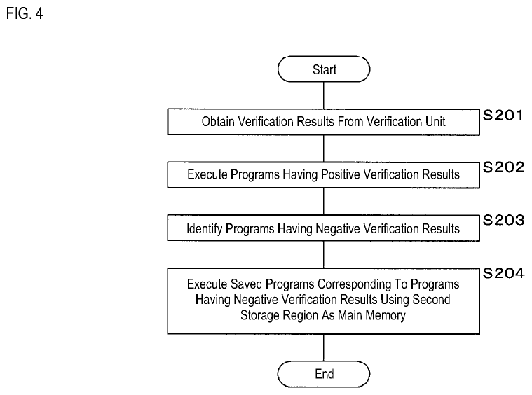

FIG. 4 is a flowchart showing an example of processing performed by the control unit 20 of an in-vehicle ECU 2 according to Embodiment 2 (in which the second storage region 212 is used as the main memory). Similarly to Embodiment 1, when the vehicle C transitions from the stopped state (in which the IG switch is OFF) to the booted state (in which the IG switch is ON), for example, the control unit 20 of the in-vehicle ECU 2 performs the following processing based on secure boot processing (secure boot sequence) that is executed when the in-vehicle ECU 2 is to be booted. Similarly to Embodiment 1, verification is initially performed in the secure boot processing by the verification unit 24 with respect to each of the plurality of programs stored in the first storage region 211. A series of processing by the control unit 20 of the in-vehicle ECU 2 is performed after verification processing is performed on each program by the verification unit 24.

The control unit 20 of the in-vehicle ECU 2 obtains verification results from the verification unit 24 (step S201). The control unit 20 of the in-vehicle ECU 2 executes (boots) programs of which verification results are positive based on the obtained verification results (step S202). The control unit 20 of the in-vehicle ECU 2 identifies programs of which verification results are negative based on the obtained verification results (step S203). The control unit 20 of the in-vehicle ECU 2 performs the processing in steps S201 to S203 similarly to the processing in steps S101 to S103 in Embodiment 1.

The control unit 20 of the in-vehicle ECU 2 executes saved programs corresponding to the programs having negative verification results, using the second storage region 212 as the main memory (step S204). The control unit 20 of the in-vehicle ECU 2 executes the saved programs respectively corresponding to the identified programs having negative verification results, using the second storage region 212, in which the saved programs are stored, as the main memory. Accordingly, memory spaces (memory regions) allocated for processes or the like of the saved programs are any regions in the second storage region 212, that is, the second storage region 212 is used as the main memory in the execution of the saved programs.

By using the second storage region 212 as the main memory in the execution of the saved programs, it is possible to eliminate the need to copy the saved programs from the second storage region 212 to the first storage region 211, and reduce the time required to perform a series of processing when executing the saved programs instead of the programs having negative verification results.

### Embodiment 3

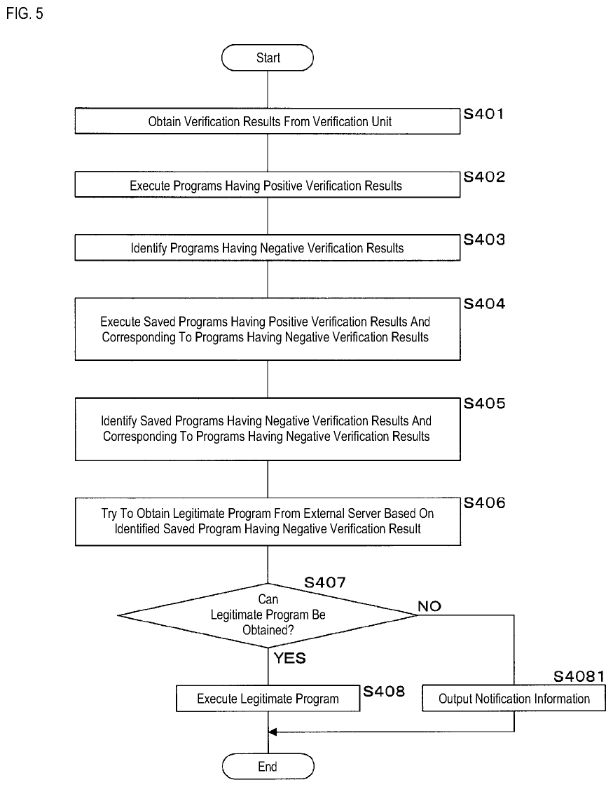

FIG. 5 is a flowchart showing an example of processing performed by the control unit 20 of an in-vehicle ECU 2 according to Embodiment 3 (in which a legitimate program is obtained from the external server 100). Similarly to Embodiment 1, when the vehicle C transitions from the stopped state (in which the IG switch is OFF) to the booted state (in which the IG switch is ON), for example, the control unit 20 of the in-vehicle ECU 2 performs the following processing based on secure boot processing (secure boot sequence) that is executed when the in-vehicle ECU 2 is to be booted.

Verification is initially performed in the secure boot processing by the verification unit 24 with respect to each of the plurality of programs stored in the first storage region 211 and each of the plurality of saved programs stored in the second storage region 212.

The control unit 20 of the in-vehicle ECU 2 obtains verification results from the verification unit 24 (step S401). The verification results output from the verification unit 24 indicate whether verification results of the respective programs stored in the first storage region 211 and verification results of the respective saved programs stored in the second storage region 212 are positive or negative. Based on the obtained verification results, the control unit 20 of the in-vehicle ECU 2 can recognize the verification result of each program stored in the first storage region 211 and the verification result of each saved program stored in the second storage region 212.

The control unit 20 of the in-vehicle ECU 2 executes (boots) programs of which verification results are positive based on the obtained verification results (step S402). The control unit 20 of the in-vehicle ECU 2 identifies programs of which verification results are negative based on the obtained verification results (step S403). The control unit 20 of the in-vehicle ECU 2 executes the processing in steps S402 and S403 similarly to the processing in steps S102 and S103 in Embodiment 1.

The control unit 20 of the in-vehicle ECU 2 executes (boots) saved programs of which verification results are positive, out of saved programs corresponding to the programs of which verification results are negative (step S404). The control unit 20 of the in-vehicle ECU 2 executes (boots) saved programs that correspond to programs having negative verification results and that have positive verification results. The control unit 20 may copy the saved programs from the second storage region 212 to the first storage region 211 and execute the saved programs using the first storage region 211 as the main memory similarly to Embodiment 1. Alternatively, the control unit 20 may execute the saved programs using the second storage region 212 as the main memory, without copying the saved programs from the second storage region 212 to the first storage region 211, similarly to Embodiment 2.

The control unit 20 of the in-vehicle ECU 2 identifies saved programs that correspond to programs having negative verification results and that have negative verification results (step S405). As for these programs having negative verification results, the verification unit 24 verified that not only the programs themselves but also saved programs corresponding to the programs have negative verification results. When a program stored in the first storage region 211 and a saved program corresponding to this program and stored in the second storage region 212 are defined as a program set, a program set of a program and a saved program both having negative verification results is a program set having negative verification results.

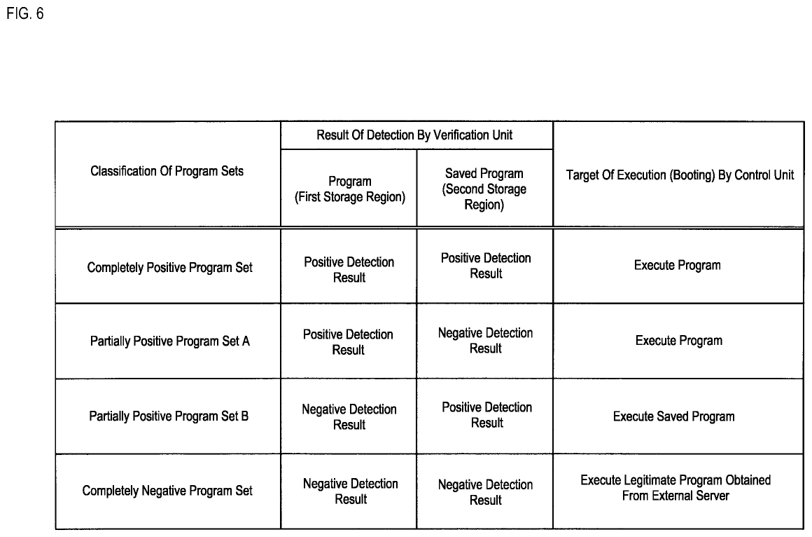

FIG. 6 is a diagram showing classification of program sets based on verification results. As the diagram illustrating the present embodiment shows, program sets are roughly classified into: a program set (completely positive program set) in which both a program and a saved program have positive verification results; a program set (partially positive program set A) in which only a program stored in the first storage region 211 has a positive verification result; a program set (partially positive program set B) in which only a saved program stored in the second storage region 212 has a positive verification result; and a program set (completely negative program set) in which both a program and a saved program have negative verification results. The saved programs having negative verification results and identified in this processing are included in completely negative program sets.

As for the completely positive program set and the partially positive program set A, the program stored in the first storage region 211 is executed. As for the partially positive program set B, the saved program stored in the second storage region 212 is executed. As for the completely negative program set, a legitimate program obtained from the external server 100 is executed as described later.

Information indicating classes of respective program sets may be stored as a program set classification table in the storage unit 21, for example. The control unit 20 of the in-vehicle ECU 2 may identify the class of each program set constituted by a program and a saved program based on the verification results obtained from the verification unit 24 and deal with each program set by referring to the program set classification table (used as a lookup table).

The control unit 20 of the in-vehicle ECU 2 tries to obtain a legitimate program from the external server 100 based on each of the identified saved programs having negative verification results (step S406). Each identified saved program having the negative verification result is included in a completely negative program set. The control unit 20 of the in-vehicle ECU 2 requests the external server 100 to transmit a legitimate program for replacing the program or the saved program having the negative verification result, based on the saved program or the program included in the completely negative program set. The legitimate program may be the original program of the program having the negative verification result, i.e., the program that has not been subjected to falsification or the like, or the latest version (update program) of the program, for example. The control unit 20 of the in-vehicle ECU 2 tries to communicate (establish a session) with the external server 100 by using the external communication device 1, for example, and outputs (transmits) a request signal requesting transmission of the legitimate program to the external server 100.

The control unit 20 of the in-vehicle ECU 2 determines whether or not the legitimate program has been obtained from the external server 100 (step S407). The control unit 20 of the in-vehicle ECU 2 determines whether or not the legitimate program has been obtained, based on a result of communication with the external server 100. A configuration is also possible in which, when the legitimate program has been obtained from the external server 100, the control unit 20 of the in-vehicle ECU 2 outputs the legitimate program to the verification unit 24, and if the result of verification performed on the legitimate program by the verification unit 24 is positive, it is determined that the legitimate program has been obtained.

If the legitimate program has been obtained (step S407: YES), the control unit 20 of the in-vehicle ECU 2 executes the obtained legitimate program (step S408). When the legitimate program has been obtained normally, the control unit 20 of the in-vehicle ECU 2 may store the obtained legitimate program in the first storage region 211 and execute the legitimate program using the first storage region 211 as the main memory similarly to Embodiment 1. Alternatively, the control unit 20 of the in-vehicle ECU 2 may store the obtained legitimate program in the second storage region 212 and execute the legitimate program using the second storage region 212 as the main memory similarly to Embodiment 2. When storing the obtained legitimate program in the first storage region 211 and the second storage region 212, the control unit 20 of the in-vehicle ECU 2 may overwrite the program and the saved program having negative verification results and respectively stored in the first storage region 211 and the second storage region 212, and substantially erase (delete) the program and the saved program having negative verification results.

If the legitimate program could not be obtained (step S407: NO), the control unit 20 of the in-vehicle ECU 2 outputs notification information (step S4081). When the legitimate program could not be obtained or the result of verification performed on the obtained legitimate program by the verification unit 24 is negative, the control unit 20 of the in-vehicle ECU 2 may output (transmit), to the external server 100, notification information indicating that a function corresponding to the program (program having the negative verification result) that could not be executed cannot be exhibited, for example. Alternatively, the control unit 20 of the in-vehicle ECU 2 may output (transmit), as the notification information, a request signal for causing an in-vehicle device 3 such as a body ECU that controls the hazard lamp or the horn to flash the hazard lamp or honk the horn, for example, via the internal communication unit 23 to the in-vehicle device 3.

Thus, it is possible to cause the hazard lamp or the horn to function as a notification unit that gives a notification to an operator of another vehicle C around the vehicle C. The notification information corresponds to information (rescue signal) indicating a function failure, that is, indicating that at least one function of the vehicle C cannot be exhibited, and thus it is possible to notify a manager of the external server 100 or the operator of the other vehicle C around the vehicle C of the occurrence of the function failure in the vehicle C in which the in-vehicle ECU 2 is mounted, to call for help and support.

### Embodiment 4

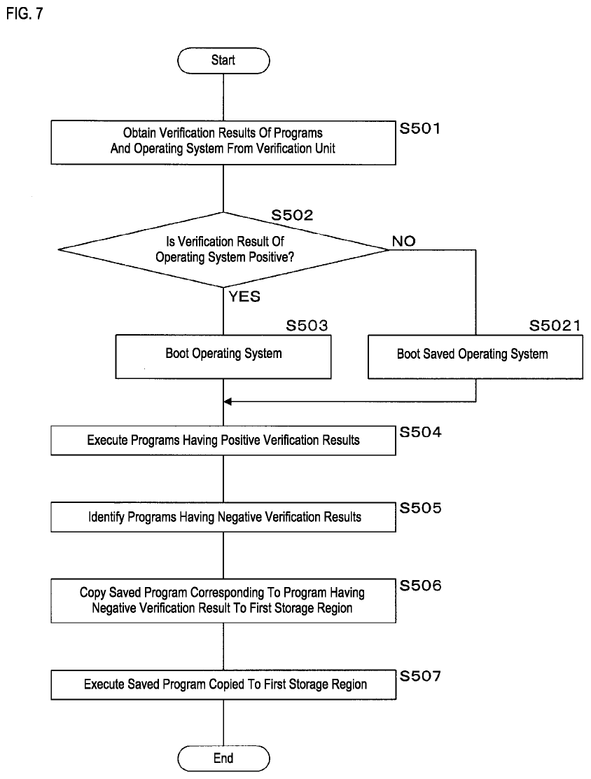

FIG. 7 is a flowchart showing an example of processing performed by the control unit 20 of an in-vehicle ECU 2 according to Embodiment 4 (in which an operating system is verified). Embodiment 4 differs from Embodiment 1 in that an operating system that generates an operation environment for executing the plurality of programs is stored in the first storage region 211 of the in-vehicle ECU 2, and a saved operating system corresponding to the operating system is stored in the second storage region 212.

The operating system stored in the first storage region 211 is an in-vehicle operating system such as an OS (Operating System) in accordance with AUTOSAR or Linux (registered trademark), for example. The saved operating system stored in the second storage region 212 may be an old version of the operating system stored in the first storage region 211 or a backup operating system of the same version as the operating system stored in the second storage region 212, as is the case with the programs.

Similarly to Embodiment 1, when the vehicle C transitions from the stopped state (in which the IG switch is OFF) to the booted state (in which the IG switch is ON), for example, the control unit 20 of the in-vehicle ECU 2 performs the following processing based on secure boot processing (secure boot sequence) that is executed when the in-vehicle ECU 2 is to be booted. In the secure boot processing, verification of a plurality of programs and the operating system stored in the first storage region 211 is initially performed by the verification unit 24.

The control unit 20 of the in-vehicle ECU 2 obtains verification results of the plurality of programs and the operating system from the verification unit 24 (step S501). The verification unit 24 constituted by an HSM, for example, verifies the plurality of programs stored in the first storage region 211 similarly to Embodiment 1, and verifies the operating system in addition to the programs. Accordingly, the verification results output from the verification unit 24 include verification results of the plurality of programs and the operating system.

The control unit 20 of the in-vehicle ECU 2 determines whether or not the verification result of the operating system is positive (step S502). The control unit of the in-vehicle ECU 2 obtains and refers to the verification result of the operating system by extracting the verification result included in the verification results output from the verification unit 24, and determines whether the verification result is positive or negative.

If the verification result of the operating system is positive (step S502: YES), the control unit 20 of the in-vehicle ECU 2 boots the operating system stored in the first storage region 211 (step S503). If the verification result of the operating system is positive, improper processing such as falsification has not been performed on the operating system stored in the first storage region 211, and adequacy (integrity) of the operating system is assured.

If the verification result of the operating system is negative (step S502: NO), the control unit 20 of the in-vehicle ECU 2 boots the saved operating system stored in the second storage region 212 (step S5021). If the verification result of the operating system is negative, improper processing such as falsification has probably been performed on the operating system having the negative verification result, and adequacy (integrity) of the operating system is negated. Therefore, the control unit 20 of the in-vehicle ECU 2 does not boot the operating system having the negative verification result, and boots the saved operating system stored in the second storage region 212. The control unit 20 of the in-vehicle ECU 2 may copy the saved operating system to the first storage region 211 and boot the saved operating system using the first storage region 211 as the main memory. Alternatively, the control unit 20 of the in-vehicle ECU 2 may boot the saved operating system using the second storage region 212 as the main memory.

The control unit 20 of the in-vehicle ECU 2 executes (boots) programs of which verification results are positive based on the obtained verification results (step S504). The control unit 20 of the in-vehicle ECU 2 identifies programs of which verification results are negative based on the obtained verification results (step S505). With respect to each program having the negative verification result, the control unit 20 of the in-vehicle ECU 2 copies a corresponding saved program to the first storage region 211 (step S506). The control unit 20 of the in-vehicle ECU 2 executes the saved programs copied to the first storage region 211 (step S507). The control unit 20 of the in-vehicle ECU 2 performs the processing in steps S504 to S507 similarly to the processing in steps S102 to S105 in Embodiment 1.

According to the present embodiment, in addition to applications, the operating system is also verified in the secure boot processing (secure boot sequence) executed when the in-vehicle ECU 2 is to be booted, and the operating system or the saved operating system is booted based on the verification result. Therefore, a secure operation environment can be established in the in-vehicle ECU 2 that boots the operating system to generate an operation environment of the applications when executing the applications.

The embodiments disclosed herein are examples in all aspects, and should not be construed as limiting the present disclosure. The scope of the present disclosure is defined not by the above descriptions but by the claims, and is intended to encompass all modifications within the meanings and scope that are equivalent to the claims.

1. An in-vehicle ECU mounted on a vehicle, comprising:
a control unit configured to execute a plurality of programs;
a verification unit configured to verify each of the plurality of programs when the ECU is to be booted;
a first storage region in which each of the plurality of programs is stored; and
a second storage region in which each of a plurality of saved programs corresponding to the plurality of programs is stored,
wherein the control unit
executes a program of which a result of verification performed by the verification unit is positive, and
does not execute a program of which a result of verification performed by the verification unit is negative, and executes a saved program corresponding to the program of which the result of verification is negative, and
if only some programs among the plurality of programs have negative verification results, the control unit executes saved programs with respect to only the programs having the negative verification results.

2. The in-vehicle ECU according to claim 1,
wherein the saved program corresponding to the program is an old-version program that is a previous version of the program or a backup program that is a backup of the program.

3. The in-vehicle ECU according to claim 1,
wherein, when executing the saved program, the control unit
copies the saved program stored in the second storage region to the first storage region and overwrites the program of which the result of verification is negative, and
executes the saved program using the first storage region as a main memory.

4. The in-vehicle ECU according to claim 1,
wherein, when executing the saved program, the control unit executes the saved program using the second storage region, in which the saved program is stored, as a main memory.

5. The in-vehicle ECU according to claim 1,
wherein the verification unit verifies a program and a saved program corresponding to the program, and
if results of verification performed on the program and the saved program by the verification unit are both negative, the control unit obtains a legitimate program of the same type as the program of which the result of verification is negative, from an external server outside the vehicle, and executes the obtained legitimate program.

6. The in-vehicle ECU according to claim 5,
wherein the control unit
copies the obtained legitimate program to the first storage region and the second storage region and overwrites the program and the saved program of which the results of verification are negative, and
executes the legitimate program using the first storage region as a main memory.

7. The in-vehicle ECU according to claim 5,
wherein, if the legitimate program cannot be obtained from the external server, the control unit outputs notification information indicating that a function corresponding to the program of which the result of verification is negative cannot be exhibited.

8. The in-vehicle ECU according to claim 1,
wherein an operating system that generates an operation environment for executing the plurality of programs is stored in the first storage region,
a saved operating system corresponding to the operating system is stored in the second storage region,
the verification unit verifies the operating system in addition to the plurality of programs,
if a result of verification performed on the operating system by the verification unit is positive, the control unit boots the operating system, and
if the result of verification performed on the operating system by the verification unit is negative, the control unit boots the saved operating system.

9. A program that causes a computer mounted on a vehicle and configured to execute a plurality of programs to execute processing for:
performing verification of each of the plurality of programs stored in a first storage region when the computer is to be booted;
executing a program of which a result of the verification is positive; and
not executing a program of which a result of the verification is negative, and executing a saved program that is stored in a second storage region different from the first storage region and corresponds to the program of which the result of the verification is negative,
wherein, if only some programs among the plurality of programs have negative verification results, saved programs are executed with respect to only the programs having the negative verification results.

10. An information processing method in which a computer mounted on a vehicle and configured to execute a plurality of programs is caused to execute processing for:
performing verification of each of the plurality of programs stored in a first storage region when the computer is to be booted;
executing a program of which a result of the verification is positive; and
not executing a program of which a result of the verification is negative, and executing a saved program that is stored in a second storage region different from the first storage region and corresponds to the program of which the result of the verification is negative,
wherein, if only some programs among the plurality of programs have negative verification results, saved programs are executed with respect to only the programs having the negative verification results.
